(19) United States
(12) Patent Application Publication
(10) Pub. No.: US 2025/0013045 A1
(43) Pub. Date: Jan. 9, 2025

(54) DISPLAY DEVICE

(71) Applicant: Panasonic Automotive Systems Co., Ltd., Kanagawa (JP)

(72) Inventors: Hiroki HARA, Osaka (JP); Keiji SUGIYAMA, Kyoto (JP)

(73) Assignee: Panasonic Automotive Systems Co., Ltd., Kanagawa (JP)

(21) Appl. No.: 18/887,785

(22) Filed: Sep. 17, 2024

Related U.S. Application Data
(63) Continuation of application No. PCT/JP2023/005245, filed on Feb. 15, 2023.

(30) Foreign Application Priority Data
Mar. 31, 2022 (JP) 2022-059644

(51) Int. Cl. G02B 27/01

(52) U.S. Cl. CPC G02B 27/0103

(57) ABSTRACT

A display device incudes: an image generating device that generates light that indicates an image (image light); a first light guide that includes a first output hologram element from which the image light exits; and a second light guide that includes a second output hologram element from which the image light exits. Each of the first light guide and the second light guide is in a curved shape. The image light emitted from the image generating device enters the first light guide. A portion of the 10 image light that has entered the first light guide enters the second light guide. A light quantity distribution of the image light exiting the first output hologram element is different from a light quantity distribution of the image light exiting the second output hologram element.

### CROSS REFERENCE TO RELATED APPLICATIONS

This is a continuation application of PCT International Application No. PCT/JP2023/005245 filed on Feb. 15, 2023, designating the United States of America, which is based on and claims priority of Japanese Patent Application No. 2022-059644 filed on Mar. 31, 2022.

### FIELD

The present disclosure relates to a display device.

### BACKGROUND

Patent Literature (PTL) 1 discloses an optical waveguide that includes a plurality of partial optical waveguides planarly formed and including optical filters.

### CITATION LIST

### Patent Literature

PTL 1: Japanese Unexamined Patent Application Publication (Translation of PCT Application) No. 2021-528681

### SUMMARY

However, the optical waveguide according to PTL 1 can be improved upon.

In view of this, the present disclosure provides a display device capable of improving upon the above related art.

A display device according to one aspect of the present disclosure includes: an image generating device that generates image light that indicates an image; a first light guide that includes a first output hologram element from which the image light exits; and a second light guide that includes a second output hologram element from which the image light exits, in which each of the first light guide and the second light guide is in a curved shape, the image light emitted from the image generating device enters the first light guide, a portion of the image light that has entered the first light guide enters the second light guide, and a light quantity distribution of the image light exiting the first output hologram element is different from a light quantity distribution of the image light exiting the second output hologram element.

Some general and specific aspects may be implemented using a system, a method, an integrated circuit, a computer program, or a computer-readable recording medium such as a CD-ROM, or any combination of systems, methods, integrated circuits, computer programs, or computer-readable recording media.

A display device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A schematically illustrates an example of a vehicle in which a display device according to the present embodiment is disposed.

FIG. 1B is a schematic diagram of the display device according to the embodiment and the vehicle viewed along a right direction.

FIG. 2 is a perspective view of the display device according to the embodiment.

FIG. 3 illustrates the display device.

FIG. 4 illustrates light of each wavelength component propagating through a first light guide, a second light guide, and a third light guide, and light quantity distributions.

FIG. 5 illustrates transmittance at virtual image positions.

FIG. 6 is a schematic diagram of a display device according to a variation of the embodiment, viewed along a right direction.

### DESCRIPTION OF EMBODIMENT

Hereinafter, an embodiment will be specifically described with reference to the drawings.

It should be noted that the embodiment described below shows a general or specific example. The numerical values, shapes, materials, structural elements, arrangement positions and connection forms of the structural elements, steps, the order of steps, etc. shown in the following embodiment are examples, and are not intended to limit the present disclosure. Moreover, among the structural elements in the embodiment below, the structural elements not described in independent claims will be described as arbitrary structural elements.

Note that the respective figures are schematic diagrams and are not necessarily precise illustrations. Additionally, the structural elements that are essentially the same share like reference numerals in the respective figures.

In the following embodiment, expressions such as “approximately orthogonal” or “rectangular in shape” will be used. For example, “approximately orthogonal” or “rectangular in shape” not only means being perfectly orthogonal or rectangular shape, but also means being substantially orthogonal or rectangular shape, that is, means a state including an error of, for example, approximately several percent. Moreover, “approximately orthogonal” or “rectangular in shape” means being orthogonal or rectangular to the extent that the effects of the present disclosure can be achieved. The same applies to expressions using other “approximately” or “shape”,

### (Embodiment)

### <Configuration: Display Device 1>

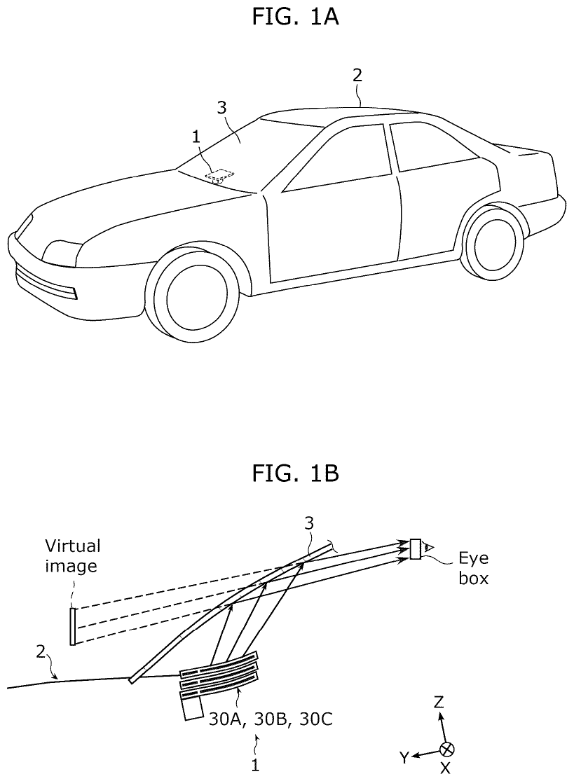

First, a configuration of display device 1 will be described with reference to FIG. 1A to FIG. 3.

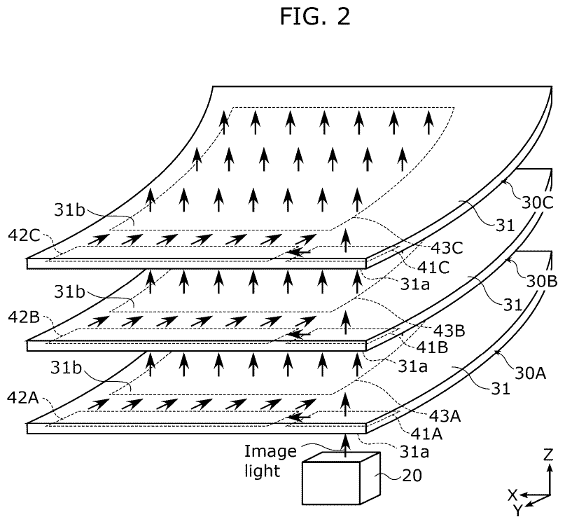

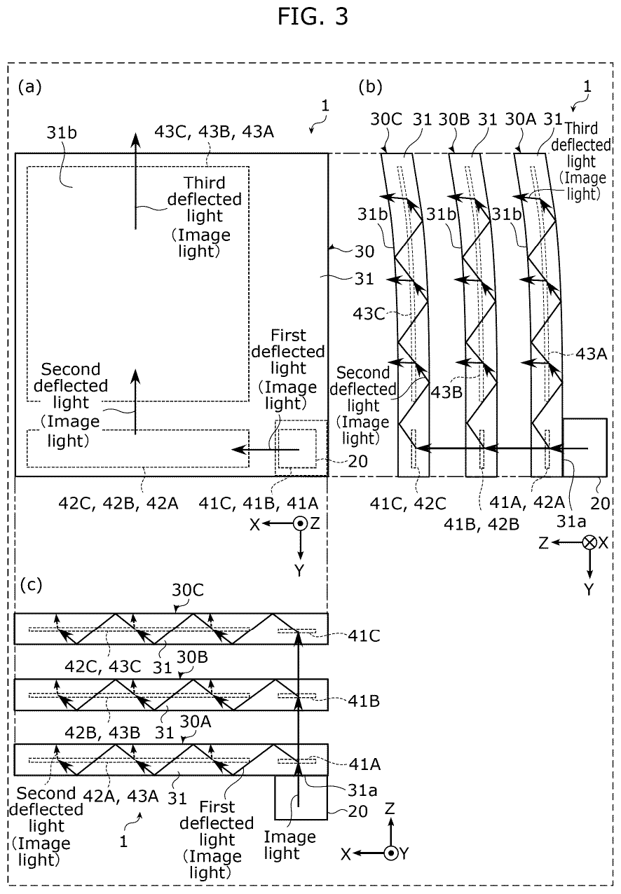

FIG. 1A schematically illustrates an example of vehicle 2 in which display device 1 according to the present embodiment is disposed. FIG. 1B is a schematic diagram of display device 1 according to the embodiment and vehicle 2 viewed along the right direction (positive x-axis direction). FIG. 2 is a perspective view of display device 1 according to the embodiment. FIG. 3 illustrates display device 1. In FIG. 3, (a) is a top view of display device 1, (b) is a side view of display device 1, and (c) is a front view of display device 1.

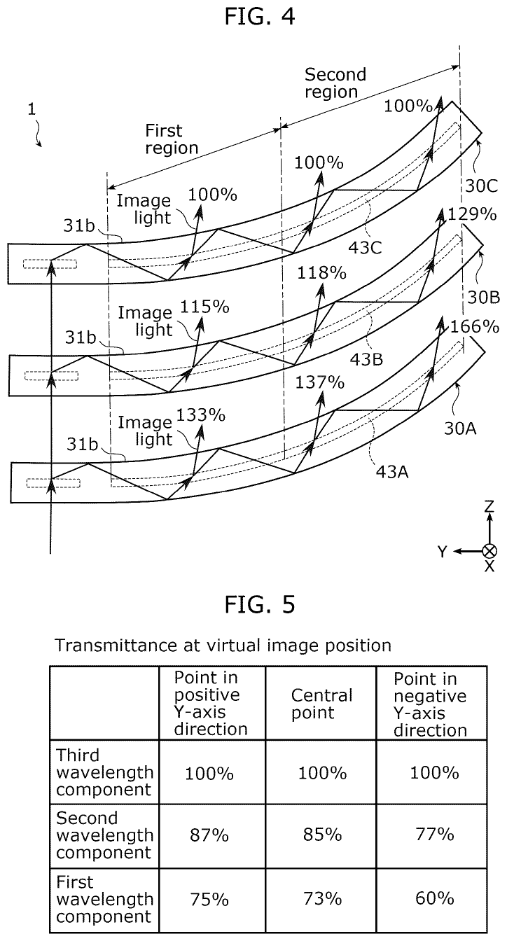

In FIG. 2, for example, the direction of arrangement of first folding hologram element 42A with respect to first input hologram element 41A is defined as the positive X-axis direction, the direction of arrangement of first folding hologram element 42A with respect to first output hologram element 43A is defined as the positive Y-axis direction, and the direction of arrangement of first input hologram element 41A with respect to image generating device 20 is defined as the positive Z-axis direction. It may also be applied as appropriate in FIG. 4 and subsequent figures.

As illustrated in FIG. 1A and FIG. 1B, display device 1 is, for example, disposed in the dashboard (also called instrument panel) of vehicle 2, such as an automobile. Windshield (also called windscreen) 3 is disposed above the dashboard of vehicle 2. First light guide 30A, second light guide 30B, and third light guide 30C of display device 1 are disposed between the dashboard and windshield 3. Each of first light guide 30A, second light guide 30B, and third light guide 30C includes light guide plate 31 that includes a diffractive optical element. Light guide plate 31 includes entrance surface 31a and exit surface 31b. A specific configuration of each of first light guide 30A, second light guide 30B, and third light guide 30C will be described later.

Display device 1 is capable of causing image light that indicates an image and that has exited first light guide 30A, second light guide 30B, and third light guide 30C to enter the eye box of a user who is, for example, the driver or passenger, by causing the image light to be reflected by windshield 3. In other words, display device 1 projects the image indicated by the image light emitted from image generating device 20 in front of windshield 3, so that a virtual image corresponding to the image is displayed on windshield 3. The image light is light that indicates an image, and displays a virtual image in front of windshield 3. The image is a still image or a moving image, such as numbers, letters, and graphics.

As illustrated in FIG. 1A and FIG. 2, display device 1 includes image generating device 20, first light guide 30A, second light guide 30B, and third light guide 30C.

### [Image Generating Device 20]

Image generating device 20 is capable of projecting a predetermined image onto windshield 3 via first light guide 30A, second light guide 30B, and third light guide 30C by emitting image light that indicates an image with a rectangular outline. Image generating device 20 is capable of emitting image light from a rectangular emitting surface. The image light emitted from image generating device 20 enters and passes through first light guide 30A, second light guide 30B, and third light guide 30C, and then exits first light guide 30A, second light guide 30B, and third light guide 30C, so that the image light is emitted to windshield 3. With this, the image light is reflected by windshield 3, and an image is projected onto windshield 3, so that the user perceives a virtual image.

Image generating device 20 includes a plurality of emitters, a plurality of dichroic mirrors, a condenser lens, a mirror, and an exit surface.

The plurality of emitters emit light beams that are in given wavelength bands that are different from one another. The plurality of dichroic mirrors are arranged on the light beams emitted by the emitters to reflect the light beam in a given wavelength band and transmit the light beams in other wavelength bands. The condenser lens is a lens that condenses the light beams emitted through the dichroic mirrors to the plurality of mirrors. The exit surface is a screen, such as a microlens array, or a liquid crystal display element such as a liquid crystal display (LCD). When light beams of different wavelength bands are emitted from the mirror side, the exit surface allows the transmitted light to exit as image light.

### [First Light Guide 30A, Second Light Guide 30B, and Third Light Guide 30C]

As illustrated in FIG. 2 and FIG. 3, each of first light guide 30A, second light guide 30B, and third light guide 30C is a holographic light guide that displays, to the user, an image indicated by image light. Each of first light guide 30A, second light guide 30B, and third light guide 30C is capable of enlarging the image indicated by the image light emitted from image generating device 20 in the x-axis and y-axis directions before the output.

Each of first light guide 30A, second light guide 30B, and third light guide 30C is in a curved shape. Specifically, each of first light guide 30A, second light guide 30B, and third light guide 30C is generally rectangular in shape when viewed along the Z-axis direction, and is in a shape of a curved plate that is bent upward on the negative Y-axis side relative to the Y-axis direction. Being bent upward on the negative Y-axis side relative to the Y-axis direction means that each of first light guide 30A, second light guide 30B, and third light guide 30C is curved to project on the negative Z-axis side.

First light guide 30A is positioned such that entrance surface 31a is opposite to image generating device 20. Second light guide 30B is positioned opposite to first light guide 30A and away from first light guide 30A by a predetermined distance, and is positioned on the positive Z-axis side of first light guide 30A. Third light guide 30C is positioned opposite to second light guide 30B and away from second light guide 30B by a predetermined distance, and is positioned on the positive Z-axis side of second light guide 30B. In other words, first light guide 30A, second light guide 30B, and third light guide 30C are arranged in this order so as to overlap with one another in the positive Z-axis direction and be positioned away from one another by a predetermined distance. With this, an air layer is provided between first light guide 30A and second light guide 30B, and an air layer is provided between second light guide 30B and third light guide 30C.

First light guide 30A includes light guide plate 31, first input hologram element 41A, first folding hologram element 42A, and first output hologram element 43A.

Light guide plate 31 has light transmitting properties, and is in a shape of a rectangular curved plate that is bent upward on the negative Y-axis side relative to the Y-axis direction.

Light guide plate 31 includes entrance surface 31a and exit surface 31b.

Entrance surface 31a is a surface from which the image light emitted from the exit surface of image generating device 20 enters. Entrance surface 31a is opposite to the exit surface of image generating device 20. Entrance surface 31a is a portion of the back surface of rectangular light guide plate 31, and is positioned at one of the four corners on the back surface. The back surface of light guide plate 31 is the side of light guide plate 31 on the opposite side of exit side 31b.

Exit surface 31b is a surface from which the image light that has entered entrance surface 31a and propagated through light guide plate 31 exits toward windshield 3. Exit surface 31b is positioned opposite to windshield 3, and away from windshield 3 by a predetermined distance. Exit surface 31b is a portion of the front surface of light guide plate 31.

First input hologram element 41A is a light-transmissive entrance diffractive optical element included in light guide plate 31. First input hologram element 41A is in a shape of a rectangular plate, and may be curved along light guide plate 31.

First input hologram element 41A and first folding hologram element 42A are arranged side by side along the X-axis. First folding hologram element 42A and first output hologram element 43A are arranged side by side along the Y-axis. When viewed along the Z-axis direction, first input hologram element 41A is arranged to overlap entrance surface 31a of light guide plate 31 and to oppose the exit surface of image generating device 20 that is arranged on the negative Z-axis side of first light guide 30A.

First input hologram element 41A causes light of a first wavelength component, which is a portion of the image light emitted from the exit surface of image generating device 20 and traveling in the positive Z-axis direction, to enter first folding hologram element 42A, and transmits light other than the first wavelength component that is the remaining image light to cause the remaining image light to enter second light guide 30B. For example, first input hologram element 41A is a wavelength-selective dichroic mirror. In the present embodiment, the first wavelength component is a wavelength component corresponding to blue.

First input hologram element 41A allows first deflected light, which is obtained by selectively deflecting the light of the first wavelength component included in the image light from image generating device 20 that has entered entrance surface 31a, to exit. Specifically, when the image light that has entered from outside of first light guide 30A propagates through first light guide 30A, first input hologram element 41A deflects, by diffraction, the light of the first wavelength component included in the image light according to the diffraction efficiency of first input hologram element 41A, so that the deflected light exits as the first deflected light (image light) of the first wavelength component propagating along the positive X-axis direction. The first deflected light of the first wavelength component deflected by diffraction by first input hologram element 41A enters first folding hologram element 42A.

First folding hologram element 42A is a light-transmissive exit diffractive optical element included in light guide plate 31. First folding hologram element 42A is in a shape of a rectangular plate that is elongated along the X-axis. First folding hologram element 42A may be curved along light guide plate 31.

First folding hologram element 42A is positioned on the positive X-axis side of first input hologram element 41A, and on the light-exiting side of first input hologram element 41A, and on the positive Y-axis side of first output hologram element 43A, and along the light-entrance side of first output hologram element 43A.

The image light of the first wavelength component having entered entrance surface 31a that is the first deflected light of the first wavelength component deflected by diffraction by first input hologram element 41A enters first folding hologram element 42A. First folding hologram element 42A further deflects, by diffraction, the image light deflected by diffraction by first input hologram element 41A to cause the deflected image light to propagate through first light guide 30A. In other words, each time the first deflected light of the first wavelength component that has passed through first input hologram element 41A enters (passes through) first folding hologram element 42A, first folding hologram element 42A causes the second deflected light (image light) of the first wavelength component, which is obtained by further deflecting, by diffraction, the first deflected light of the first wavelength component, to exit toward first output hologram element 43A. Specifically, when the first deflected light of the first wavelength component propagates through first light guide 30A in the positive X-axis direction, first folding hologram element 42A deflects, by diffraction, the first deflected light of the first wavelength component included in the image light according to the diffraction efficiency of first folding hologram element 42A, so that the deflected light exits as the second deflected light (image light) of the first wavelength component propagating in the negative Y-axis direction. At this time, first folding hologram element 42A serves to enlarge the image of the image light in the x-axis direction. First folding hologram element 42A causes the second deflected light of the first wavelength component to exit in the negative Y-axis direction. The second deflected light of the first wavelength component enters first output hologram element 43A.

First output hologram element 43A is a light-transmissive exit diffractive optical element included in light guide plate 31. When viewed along the Z-axis direction, first output hologram element 43A is rectangular in shape, and is in a shape of a curved plate that is bent upward on the negative Y-axis side relative to the Y-axis direction.

First output hologram element 43A is positioned on the negative Y-axis side of first folding hologram element 42A and is opposite to the light exit side of first folding hologram element 42A. First output hologram element 43A is positioned so as to overlap and oppose exit surface 31b of first light guide 30A.

The second deflected light of the first wavelength component that has exited first folding hologram element 42A enters first output hologram element 43A. First output hologram element 43A further deflects, by diffraction, the image light deflected by first folding hologram element 42A, so that the deflected light exits first light guide 30A. In other words, each time the second deflected light of the first wavelength component that has passed through first folding hologram element 42A enters (passes through) first output hologram element 43A, first output hologram element 43A causes the third deflected light (image light) of the first wavelength component, which is obtained by further deflecting, by diffraction, the second deflected light of the first wavelength component that has entered, to exit at a predetermined exit angle. Specifically, when the second deflected light of the first wavelength component deflected by diffraction by first folding hologram element 42A propagates through first light guide 30A in the negative Y-axis direction, first output hologram element 43A deflects, by diffraction, the second deflected light of the first wavelength component included in the image light according to the diffraction efficiency of first output hologram element 43A. Then, the second deflected light exits first output hologram element 43A as third deflected light of the first wavelength component propagating in the positive Z-axis direction. At this time, first output hologram element 43A serves to further enlarge, in the y-axis direction, the image of the second deflected light of the first wavelength component enlarged in the x-axis direction. In other words, first output hologram element 43A further enlarges, in the Y-axis direction, the image indicated by the image light emitted from image generating device 20, so that the image light of the image enlarged in the X-axis and Y-axis directions exits. First output hologram element 43A causes the third deflected light of the first wavelength component to exit in the positive Z-axis direction. The third deflected light of the first wavelength component exits exit surface 31b. With this, the third deflected light (image light) of the first wavelength component that has exited exit surface 31b enters second light guide 30B.

Since the configuration of second light guide 30B is similar to the configuration of first light guide 30A, specific descriptions thereof are omitted as appropriate. Second light guide 30B includes light guide plate 31, second input hologram element 41B, second folding hologram element 42B, and second output hologram element 43B.

Light of a wavelength component other than the light of the first wavelength component that is the image light that has exited first input hologram element 41A of first light guide 30A enters second light guide 30B.

Second input hologram element 41B causes the light of the second wavelength component included in the remaining image light (light other than the first wavelength component) that has exited first input hologram element 41A of first light guide 30A to enter second folding hologram element 42B. Second input hologram element 41B further transmits light other than the second wavelength component that is the remaining image light to cause the remaining image light to enter third light guide 30C. For example, second input hologram element 41B is a wavelength-selective dichroic mirror. The second wavelength component is different from the first wavelength component in wavelength. In the present embodiment, the second wavelength component is a wavelength component that is shorter than the first wavelength component and corresponds to green.

Second input hologram element 41B allows second deflected light, which is obtained by selectively deflecting the light of the second wavelength component included in the image light that has passed through first input hologram element 41A, to exit. Specifically, when the image light that has entered from the outside of second light guide 30B propagates through second light guide 30B, second input hologram element 41B deflects, by diffraction, the light of the second wavelength component included in the image light according to the diffraction efficiency of second input hologram element 41B, so that the deflected light exits as the second deflected light (image light) of the second wavelength component propagating in the positive X-axis direction. The second deflected light of the second wavelength component deflected by diffraction by second input hologram element 41B enters second folding hologram element 42B.

Second folding hologram element 42B further deflects, by diffraction, the image light deflected by diffraction by second input hologram element 41B to cause the deflected light to propagate through second light guide 30B. In other words, each time the second deflected light of the second wavelength component that has passed through second input hologram element 41B enters (passes through) second folding hologram element 42B, second folding hologram element 42B causes the second deflected light (image light) of the second wavelength component, which is obtained by further deflecting, by diffraction, the second deflected light of the second wavelength component that has entered, to exit toward second output hologram element 43B. Specifically, when the first deflected light of the second wavelength component propagates through second light guide 30B in the positive X-axis direction, second folding hologram element 42B deflects, by diffraction, the first deflected light of the second wavelength component included in the image light according to the diffraction efficiency of second folding hologram element 42B, so that the deflected light exits as the second deflected light (image light) of the second wavelength component propagating in the negative Y-axis direction.

Second output hologram element 43B further deflects, by diffraction, the image light deflected by diffraction by second folding hologram element 42B, so that the deflected light exits second light guide 30B. In other words, each time the second deflected light of the second wavelength component that has passed through second folding hologram element 42B enters (passes through) second output hologram element 43B, second output hologram element 43B causes the third deflected light (image light) of the second wavelength component, which is obtained by further deflecting, by diffraction, the second deflected light of the second wavelength component that has entered, to exit at a predetermined exit angle. Specifically, when the second deflected light of the second wavelength component deflected by diffraction by second folding hologram element 42B propagates through second light guide 30B in the negative Y-axis direction, second output hologram element 43B deflects, by diffraction, the second deflected light of the second wavelength component included in the image light according to the diffraction efficiency of second output hologram element 43B, so that the deflected light exits as the third deflected light of the second wavelength component propagating in the positive Z- axis direction.

The third deflected light of the first wavelength component, which is the image light that has exited first output hologram element 43A of first light guide 30A, enters and passes through second light guide 30B. In other words, second light guide 30B transmits the third deflected light of the first wavelength component and causes the transmitted light to enter third light guide 30C.

Since the configuration of third light guide 30C is similar to the configurations of first light guide 30A and second light guide 30B, specific descriptions thereof will be appropriately omitted. Third light guide 30C includes light guide plate 31, third input hologram element 41C, third folding hologram element 42C, and third output hologram element 43C.

Light other than the first wavelength component and the second wavelength component which is the image light that has exited second input hologram element 41B of second light guide 30B enters third light guide 30C.

Third input hologram element 41C causes light of the third wavelength component included in the remaining image light (light other than the first and second wavelength components) that has exited second input hologram element 41B of second light guide 30B to enter third folding hologram element 42C. For example, third input hologram element 41C is a wavelength-selective dichroic mirror. Third wavelength component is different from the first wavelength component and the second wavelength component in wavelength. In the present embodiment, the third wavelength component is a wavelength component that is shorter than the second wavelength component and corresponds to red.

Third input hologram element 41C allows third deflected light, obtained by selectively deflecting the light of the third wavelength component included in the image light that has passed through second input hologram element 41B, to exit. Specifically, when the image light that has entered from the outside of third light guide 30C propagates through third light guide 30C, third input hologram element 41C deflects, by diffraction, the light of the third wavelength component included in the image light according to the diffraction efficiency of third input hologram element 41C, so that the deflected light exits as the third deflected light (image light) of the third wavelength component propagating in the positive X-axis direction. The third deflected light of the third wavelength component deflected by diffraction by third input hologram element 41C enters third folding hologram element 42C.

Third folding hologram element 42C further deflects, by diffraction, the image light deflected by diffraction by the third input hologram element 41C to cause the deflected light to propagate through third light guide 30C. In other words, each time the second deflected light of the third wavelength component that has passed through third input hologram element 41C enters (passes through) third folding hologram element 42C, third folding hologram element 42C causes the second deflected light (image light) of the third wavelength component, which is obtained by further deflecting, by diffraction, the second deflected light of the third wavelength component that has entered, to exit toward third output hologram element 43C. Specifically, when the first deflected light of the third wavelength component propagates through third light guide 30C in the positive X-axis direction, third folding hologram element 42C deflects, by diffraction, the first deflected light of the third wavelength component included in the image light according to the diffraction efficiency of third folding hologram element 42C, so that the deflected light exits as the second deflected light (image light) of the third wavelength component propagating in the negative Y-axis direction.

Third output hologram element 43C further deflects, by diffraction, the image light deflected by diffraction by third folding hologram element 42C, so that the deflected light exits third light guide 30C. In other words, each time the second deflected light of the third wavelength component that has passed through third folding hologram element 42C enters (passes through) third output hologram element 43C, third output hologram element 43C causes the third deflected light (image light) of the third wavelength component, which is obtained by further deflecting, by diffraction, the second deflected light of the third wavelength component that has entered, to exit at a predetermined exit angle. Specifically, when the second deflected light of the third wavelength component deflected by diffraction by third folding hologram element 42C propagates through third light guide 30C in the negative Y-axis direction, third output hologram element 43C deflects, by diffraction, the second deflected light of the third wavelength component included in the image light according to the diffraction efficiency of third output hologram element 43C, so that the deflected light exits third output hologram element 43C as third deflected light of the third wavelength component propagating in the positive Z-axis direction.

The third deflected light of the first wavelength component, which is the image light that has exited first output hologram element 43A of first light guide 30A, enters and passes through third light guide 30C. In addition, the third deflected light of the second wavelength component, which is the image light that has exited second output hologram element 43B of second light guide 30B, enters and passes through third light guide 30C. In other words, third light guide 30C transmits the third deflected light of the first wavelength component and the third deflected light of the second wavelength component, so that the third deflected light of the first wavelength component and the third deflected light of the second wavelength component exit third light guide 30C together with the third deflected light of the third wavelength component.

Although first input hologram element 41A, second input hologram element 41B, and third input hologram element 41C are similarly configured, they select different wavelength components, and contribute to the exiting of the first deflected light of the first to third wavelength components.

Although first folding hologram element 42A, second folding hologram element 42B, and third folding hologram element 42C are similarly configured, they select different wavelength components, and contribute to the exiting of the second deflected light of the first to third wavelength components.

Although first output hologram element 43A, second output hologram element 43B, and third output hologram element 43C are similarly configured, they select different wavelength components, and contribute to the exiting of the third deflected light of the first to third wavelength components.

The exit angles of the third deflected light of the first to third wavelength components exiting the exit surfaces of first output hologram element 43A, second output hologram element 43B, and third output hologram element 43C are the angles of the exiting light relative to the normal of the surface of first output hologram element 43A.

First output hologram element 43A, second output hologram element 43B, and third output hologram element 43C may spread the exiting image light so that the exit angles of the third deflected light of the first to third wavelength components are different. When first output hologram element 43A, second output hologram element 43B, and third output hologram element 43C deflect, by diffraction, the image light that has entered, the exit angle may differ depending on the position (portion) on first output hologram element 43A, second output hologram element 43B, and third output hologram element 43C.

With this, first output hologram element 43A, second output hologram element 43B, and third output hologram element 43C are capable of causing portions of the image light deflected by diffraction by first output hologram element 43A, second output hologram element 43B, and third output hologram element 43C to exit at different exit angles.

### [Light Quantity Distribution]

The light quantity distributions in first light guide 30A, second light guide 30B, and third light guide 30C will be described next with reference to FIG. 4 and FIG. 5.

FIG. 4 illustrates light of each wavelength component propagating through first light guide 30A, second light guide 30B, and third light guide 30C, respectively, and light quantity distributions. FIG. 5 illustrates the transmittance at virtual image positions.

As illustrated in FIG. 4 and FIG. 5, the light quantity distribution of first output hologram element 43A is different from the light quantity distribution of second output hologram element 43B and the light quantity distribution of third output hologram element 43C. The light quantity distribution of second output hologram element 43B is different from the light quantity distribution of third output hologram element 43C. In the present embodiment, first output hologram element 43A, second output hologram element 43B, and third output hologram element 43C are arranged in the positive Z-axis direction in this order, so that the light quantity distribution of the exiting image light decreases in this order.

Specifically, because an air layer is provided between first light guide 30A and second light guide 30B, a portion of the image light that has exited first light guide 30A is reflected by the back surface of second light guide 30B that is the interface between second light guide 30B and the air layer. Moreover, because an air layer is provided between second light guide 30B and third light guide 30C, a portion of the image light that has exited first light guide 30A and passed through second light guide 30B is reflected by the back surface of third light guide 30C that is the interface between third light guide 30C and the air layer. Moreover, a portion of the image light that has exited second light guide 30B is reflected by the back surface of third light guide 30C that is the interface between third light guide 30C and the air layer.

With this, in order to emit, to windshield 3, light with reduced luminance unevenness, it is required to, for example, set the light quantity distribution of the image light exiting first light guide 30A, which is positioned lowest, to be larger than the respective light quantity distributions of second light guide 30B and third light guide 30C, and to set the light quantity distribution of the image light exiting second light guide 30B, which is positioned second lowest, to be larger than the light quantity distribution of third light guide 30C. At least, the light quantity distribution in a predetermined region of second output hologram element 43B is smaller than the light quantity distribution in the region of first output hologram element 43A corresponding to the predetermined region. At least, the light quantity distribution in a predetermined region of third output hologram element 43C is smaller than the light quantity distribution in the region of second output hologram element 43B corresponding to the predetermined region. In other words, it can be said that the light quantity distribution at a predetermined position on second output hologram element 43B is smaller than the light quantity distribution at a position on first output hologram element 43A corresponding to the predetermined position.

Therefore, in display device 1 according to the present embodiment, it is possible that light of the first wavelength component exits first light guide 30A that is positioned lowest, light of the second wavelength component exits second light guide 30B that is positioned in the middle, and light of the third wavelength component exits third light guide 30C that is positioned highest.

In the present embodiment, the output is gradually reduced from first light guide 30A that is positioned lowest to third light guide 30C that is positioned highest. This depends on the output of a plurality of emitters included in image generating device 20. Specifically, among the plurality of emitters in image generating device 20, a first emitter is capable of emitting light of a blue wavelength component, a second emitter is capable of emitting light of a green wavelength component, and a third emitter is capable of emitting light of a red wavelength component. The output of the third emitter for the light beam of the red wavelength component is lower than the outputs of the other emitters, and thus, the high output of the light beam of the red wavelength component tends to be difficult. The output of the second emitter for the light beam of the green wavelength component tends to be lower than the output of the first emitter. The output of the third emitter for the light beam of the blue wavelength component is highest. Therefore, in the present embodiment, the light of the third wavelength component, which is a red light beam, exits third light guide 30C that is positioned highest and closest to windshield 3, the light of the second wavelength component, which is a green light beam, exits second light guide 30B that is positioned in the middle, and the light of the first wavelength component, which is a blue light beam, exits first light guide 30A that is positioned lowest.

By adjusting the quantity of light entering each of first input hologram element 41A, second input hologram element 41B, and third input hologram element 41C, the light quantity distribution of the image light exiting first light guide 30A that is positioned lowest may be set to be smaller than the light quantity distribution of each of second light guide 30B and third light guide 30C. The light quantity distribution of the image light exiting second light guide 30B that is positioned second lowest may be set to be smaller than the light quantity distribution of third light guide 30C.

In the image light entering first light guide 30A, the light quantity distribution of the image light exiting first output hologram element 43A (may be referred to as the light quantity distribution of first output hologram element 43A) differs depending on the position on first output hologram element 43A.

Specifically, the light quantity distribution of first output hologram element 43A differs depending on the horizontal position on first output hologram element 43A.

More specifically, first output hologram element 43A includes a first region and a second region that is different from the first region. The first region is the region in first output hologram element 43A closer to first folding hologram element 42A, that is, on the positive Y-axis direction side. The second region is the region in first output hologram element 43A that is further from first folding hologram element 42A, that is, on the negative Y-axis direction side.

The light quantity distribution in the first region of first output hologram element 43A is smaller than the light quantity distribution in the second region of first output hologram element 43A. In other words, the light quantity distribution increases as the position on first output hologram element 43A becomes further away from first folding hologram element 42A in the negative Y-axis direction. The light quantity distribution of the image light exiting first output hologram element 43A depends on the diffraction efficiency, which is the ratio of the intensity of the image light diffracted by first output hologram element 43A to the intensity of the image light entering first output hologram element 43A. Although first output hologram element 43A is divided into two regions in the present embodiment, first output hologram element 43A may be divided into three or more regions. In this case, too, the light quantity distribution may increase as the position on first output hologram element 43A becomes further away from first folding hologram element 42A in the negative Y-axis direction.

The light quantity distribution of the image light exiting second output hologram element 43B (it may be referred to as the light quantity distribution of second output hologram element 43B) differs depending on the position on second output hologram element 43B. Specifically, the light quantity distribution of second output hologram element 43B differs depending on the horizontal position on second output hologram element 43B. More specifically, second output hologram element 43B includes a first region and a second region that is different from the first region. The first region is the region in second output hologram element 43B that is closer to second folding hologram element 42B, that is, on the positive Y-axis direction side. The second region is the region in second output hologram element 43B that is further from second folding hologram element 42B, that is, on the negative Y-axis direction side. The light quantity distribution in the first region of second output hologram element 43B is smaller than the light quantity distribution in the second region of second output hologram element 43B. In other words, the light quantity distribution in the first region of second output hologram element 43B (an example of a region of first output hologram element 43A) corresponding to the first region of first light guide 30A is smaller than the light quantity distribution in the second region of second output hologram element 43B (an example of a region of second output hologram element 43B) corresponding to the second region of first light guide 30A. In other words, the light quantity distribution increases as the position on second output hologram element 43B becomes further away from second folding hologram element 42B in the negative Y-axis direction. The light quantity distribution of the image light exiting second output hologram element 43B depends on the diffraction efficiency, which is the ratio of the intensity of the image light diffracted by second output hologram element 43B to the intensity of the image light entering second output hologram element 43B. Although second output hologram element 43B is divided into two regions in the present embodiment, second output hologram element 43B may be divided into three or more regions. In this case, too, the light quantity distribution may increase as the position on second output hologram element 43B becomes further away from second folding hologram element 42B in the negative Y-axis direction.

Third output hologram element 43C includes a first region and a second region that is different from the first region. The first region is the region in third output hologram element 43C that is closer to third folding hologram element 42C, that is, on the positive Y-axis direction side. The second region is the region in third output hologram element 43C that is further from third folding hologram element 42C, that is, on the negative Y-axis direction side. The first region of third output hologram element 43C has approximately the same light quantity distribution as the second region of third output hologram element 43C.

Specifically, for example, the transmittance at the virtual image position of the light of the third wavelength component exiting each of a point in the positive Y-axis direction, the central point, and a point in the negative Y-axis direction of third light guide 30C is 100%. The transmittance at the virtual image position of the light of the second wavelength component exiting a point in the positive Y-axis direction of second light guide 30B is 87%, the transmittance at the virtual image position of the light of the second wavelength component exiting the central point of second light guide 30B is 85%, and the transmittance at the virtual image position of the light of the second wavelength component exiting a point in the negative Y-axis direction of second light guide 30B is 77%. The transmittance at the virtual image position of the light of the first wavelength component exiting a point in the positive Y-axis direction of first light guide 30A is 75%, the transmittance at the virtual image position of the light of the first wavelength component exiting the central point of first light guide 30A is 73%, and the transmittance at the virtual image position of the light of the first wavelength component exiting a point in the negative Y-axis direction of first light guide 30A is 60%.

In order to prevent image unevenness in the image light (light of the first wavelength component, light of the second wavelength component, and light of the third wavelength component) emitted to the entrance surface of windshield 3, the respective light quantity distributions of the light of the first wavelength component, light of the second wavelength component, and light of the third wavelength component may be set to 100% (approximately uniform luminance). For example, display device 1 may emit light of the first wavelength component, light of the second wavelength component, and light of the third wavelength component such that the respective light quantity distributions of the light of the first wavelength component, the light of the second wavelength component, and the light of the third wavelength component included in the image light that has entered and reflected by the entrance surface of windshield 3 is 100% (approximately uniform luminance). In this case, display device 1 emits light of the first wavelength component, light of the second wavelength component, and light of the third wavelength component according to the reflectance distribution of windshield 3. Therefore, the respective light quantity distributions of the light of the first wavelength component, the light of the second wavelength component, and the light of the third wavelength component directly emitted by display device 1 may be non-uniform.

For example, the respective light quantity distributions at a point in the positive Y-axis direction, the central point, and a point in the negative Y-axis direction in third output hologram element 43C of third light guide 30C may be set to 100%. In other words, the diffraction efficiency of third output hologram element 43C may be approximately uniform over the entire third output hologram element 43C. In this case, the light of the third wavelength component that has exited third light guide 30C has a light quantity distribution of approximately 100% at the entrance surface of windshield 3.

The light quantity distributions at a point in the positive Y-axis direction, the central point, and a point in the negative Y-axis direction on second output hologram element 43B of second light guide 30B are set to be 115%, 118%, and 129%, respectively. For example, by multiplying the transmittance of 87% at the virtual image position of the light of the second wavelength component that has exited the point in the positive Y-axis direction of second light guide 30B by the light quantity distribution of 115% at the point in the positive Y-axis direction of second output hologram element 43B, the light quantity distribution becomes approximately 100% at the entrance surface of windshield 3.

The light quantity distributions at a point in the positive Y-axis direction, the center point, and a point in the negative Y-axis direction on first output hologram element 43A of first light guide 30A are set to be 133%, 137%, and 166%, respectively. For example, by multiplying the transmittance of 75% at the virtual image position of the light of the first wavelength component exiting the point in the positive Y-axis direction of first light guide 30A by the light quantity distribution of 133% at the point in the positive Y-axis direction of first output hologram element 43A, the light quantity distribution becomes approximately 100% at the entrance surface of windshield 3.

As described above, the exit holograms at respective layers have different light quantity distributions, and the light quantity distribution differs depending on the position on each exit hologram. This allows the exit holograms to compensate for uneven luminance on the entrance surface of windshield 3, i.e., to avoid unevenness in the image. The exit holograms here are generic terms for first output hologram element 43A, second output hologram element 43B, and third output hologram element 43C.

When generating the image light, image generating device 20 may adjust the gray scale values in the image light. For example, image generating device 20 may adjust the gray scale value of the image indicated by the image light for each wavelength component. The gray scale values in the image light may be adjusted as factory settings. Moreover, as described above, the light quantity distribution of each exit hologram may be adjusted, as well as the gray scale values in the image light generated by image generating device 20 may be adjusted. Furthermore, when sensors in the vehicle are monitoring the driver, the gray scale values in the image light generated by image generating device 20 may be adjusted according to the position of the eye box of the driver.

### [Angle of Light]

Next, the angle of light exiting first light guide 30A, second light guide 30B, and third light guide 30C will be described. The angle of light here refers to the angle of light in the traveling direction relative to the tangent of the respective surfaces of first light guide 30A, second light guide 30B, and third light guide 30C.

The angle of the image light exiting first light guide 30A relative to exit surface 31b that is the surface of first light guide 30A differs depending on the exit position of the image light on exit surface 31b of first light guide 30A. Specifically, the average value of the angles of the image light exiting the first region (an example of a region of second light guide 30B) of second light guide 30B corresponding to the first region of first light guide 30A is greater than the average value of the angles of the image light exiting the second region (an example of a region of second light guide 30B) of second light guide 30B corresponding to the second region of first light guide 30A. In other words, the closer the position of first light guide 30A is to the negative Y-axis direction, the more first light guide 30A is bent towards the positive Z-axis direction, so that the angle of the image light exiting exit surface 31b of first light guide 30A is smaller toward the negative Y-axis direction. Since the light quantity distribution of first output hologram element 43A increases toward the negative Y-axis direction, it can be said that the smaller the angle of the image light exiting first light guide 30A, the larger the light quantity distribution of first output hologram element 43A.

The angle of the image light exiting second light guide 30B relative to exit surface 31b that is the surface of second light guide 30B differs depending on the exit position of the image light on exit surface 31b of second light guide 30B. Specifically, the average value of the angles of the image light exiting the first region of second light guide 30B corresponding to the first region of first light guide 30A is greater than the average value of the angles of the image light exiting the second region of second light guide 30B corresponding to the second region of first light guide 30A. In other words, the closer second light guide 30B is to the negative Y-axis direction, the more second light guide 30B is bent towards the positive Z-axis direction, so the angle of the image light exiting exit surface 31b of second light guide 30B is smaller toward the negative Y-axis direction. Since the light quantity distribution of second output hologram element 43B increases toward the negative Y-axis direction, it can be said that the smaller the angle of the image light exiting second light guide 30B, the larger the light quantity distribution of second output hologram element 43B.

### <Operation and Effect>

Next, an operation and effect of display device 1 according to the present embodiment will be described.

For example, in the optical waveguide disclosed in PTL 1, the rate of Fresnel reflection that occurs when light that has exited a partial optical waveguide positioned lower of a plurality of partial optical waveguides passes through a partial optical waveguide positioned higher varies depending on the position on the partial optical waveguide. In this case, such a problem occurs that the image displayed by the partial optical waveguide positioned lower includes unevenness. In view of the above, as described above, display device 1 according to the present embodiment includes image generating device 20 that generates light that indicates an image (image light), first light guide 30A that includes first output hologram element 43A from which the image light exits, and second light guide 30B that includes second output hologram element 43B from which the image light exits. Each of first light guide 30A and second light guide 30B is in a curved shape. The image light emitted from image generating device 20 enters first light guide 30A. A portion of the image light that has entered first light guide 30A enters second light guide 30B. The light quantity distribution of the image light exiting first output hologram element 43A is different from the light quantity distribution of the image light exiting second output hologram element 43B.

With this, by adjusting the light quantity distribution of the image light exiting first output hologram element 43A and the light quantity distribution of the image light exiting second output hologram element 43B, unevenness in the image displayed on a display medium such as windshield 3 can be reduced even when each of first light guide 30A and second light guide 30B is in a curved shape.

Therefore, display device 1 is capable of reducing a decrease in the quality of the image displayed on the display medium.

In display device 1 according to the present embodiment, first light guide 30A is curved to be bent upward relative to the horizontal direction. The light quantity distribution of the image light exiting first output hologram element 43A differs depending on the horizontal position on first output hologram element 43A. With this, even when each of first light guide 30A and second light guide 30B is in a curved shape, a light quantity distribution can be formed in the image light exiting first output hologram element 43A so as to compensate for the Fresnel loss that occurs when a portion of the image light that has entered first light guide 30A enters second light guide 30B. As a result, it is possible to further reduce a decrease in the quality of the image displayed on the display medium.

In display device 1 according to the present embodiment, the angle of the image light exiting first light guide 30A relative to the surface of first light guide 30A differs depending on the exit position of the image light on the surface of first light guide 30A.

With this, even when each of first light guide 30A and second light guide 30B is in a curved shape, an image can be displayed on the display medium in a large size without distortion.

In display device 1 according to the present embodiment, the light quantity distribution of the image light exiting first output hologram element 43A increases with a decrease in the angle of the image light exiting first light guide 30A.

With this, the farther away from the region of first light guide 30A from which the image light enters, the larger the light quantity distribution of the image light exiting first output hologram element 43A can be set. Therefore, it is possible that image light with further reduced image unevenness exits first light guide 30A.

In display device 1 according to the present embodiment, first output hologram element 43A includes a first region and a second region that is different from the first region. The average value of the angles of the image light exiting the region in first light guide 30A corresponding to the first region is greater than the average value of the angles of the image light exiting the region in first light guide 30A corresponding to the second region. The light quantity distribution in the first region of first output hologram element 43A is smaller than the light quantity distribution in the second region of first output hologram element 43A.

With this, it is possible to set the light quantity distribution in the second region, which is farther from the light entering region of first light guide 30A from which the image light enters than the first region that is positioned closer to the light entering region, to be larger than the light quantity distribution in the first region. Therefore, it is possible that image light with further reduced image unevenness exits first light guide 30A.

Moreover, display device 1 according to the present embodiment further includes third light guide 30C that is in a curved shape and includes third output hologram element 43C. A portion of the light that has entered first light guide 30A enters second light guide 30B. A portion of the light that has entered second light guide 30B enters third light guide 30C. The light quantity distribution of the image light exiting second exit hologram element 43B differs depending on the horizontal position on second exit hologram element 43B.

With this, even when each of first light guide 30A, second light guide 30B, and third light guide 30C is in a curved shape, a light quantity distribution can be formed in the image light exiting second output hologram element 43B so as to compensate for the Fresnel loss that occurs when a portion of the image light that has entered second light guide 30B enters third light guide 30C. Moreover, a light quantity distribution can be formed in the image light exiting first output hologram element 43A so as to compensate for the Fresnel loss that occurs when a portion of the image light that has entered first light guide 30A enters second light guide 30B. As a result, it is possible to further reduce a decrease in the quality of the image displayed on the display medium.

In display device 1 according to the present embodiment, the angle of the image light exiting second light guide 30B relative to the surface of second light guide 30B differs depending on the exiting position of the image light on the surface of second light guide 30B. The light quantity distribution of the image light exiting second output hologram element 43B increases with a decrease in the angle of the image light exiting second light guide 30B. The light quantity distribution at a predetermined position of second exit hologram element 43B is smaller than the light quantity distribution at the position of first exit hologram element 43A corresponding to the predetermined position.

With this, in a similar manner to first light guide 30A, the farther away from the region of second light guide 30B from which the image light enters, the larger the light quantity distribution of the image light exiting second output hologram element 43B can be set. Therefore, it is possible that image light with further reduced image unevenness exits second light guide 30B.

Moreover, the light quantity distribution of first output hologram element 43A, which is positioned lower than second output hologram element 43B, can be set to be larger than the light quantity distribution of second output hologram element 43B positioned higher than first output hologram element 43A.

Therefore, a light quantity distribution can be formed in the image light exiting first output hologram element 43A so as to compensate for the Fresnel loss that occurs when a portion of the image light that entered first light guide 30A enters second light guide 30B.

In display device 1 according to the present embodiment, first output hologram element 43A includes a first region and a second region that is different from the first region. Moreover, the angle of the image light exiting second light guide 30B relative differs depending on the exiting position of the image light on the surface of second light guide 30B. Moreover, an average value of angles of the image light exiting a region of second light guide 30B corresponding to the first region is greater than an average value of angles of the image light exiting a region of second light guide 30B corresponding to the second region. Moreover, the light quantity distribution in the region of second output hologram element 43B corresponding to the first region is smaller than the light quantity distribution in the region of second output hologram element 43B corresponding to the second region. The light quantity distribution in a predetermined region of second exit hologram element 43B is smaller than the light quantity distribution in the region of first exit hologram element 43A corresponding to the predetermined region.

With this, in a similar manner to first light guide 30A, the farther away from the region of second light guide 30B from which the image light enters, the larger the light quantity distribution of the image light exiting second output hologram element 43B can be set. Therefore, it is possible that image light with further reduced image unevenness exits second light guide 30B.

Moreover, the light quantity distribution of first output hologram element 43A, which is positioned lower than second output hologram element 43B, can be set to be larger than the light quantity distribution of second output hologram element 43B positioned higher than first output hologram element 43A. Therefore, a light quantity distribution can be formed in the image light exiting first output hologram element 43A so as to compensate for the Fresnel loss that occurs when a portion of the image light that has entered first light guide 30A enters second light guide 30B.

Moreover, in display device 1 according to the present embodiment, first light guide 30A further includes: first input hologram element 41A that deflects, by diffraction, the image light that has entered from an outside of first light guide 30A and causes the image light deflected to propagate through first light guide 30A; and first folding hologram element 42A that further deflects, by diffraction, the image light diffracted by first input hologram element 41A and causes the image light further deflected to propagate through first light guide 30A. Moreover, second light guide 30B further includes: second input hologram element 41B that deflects, by diffraction, the image light that has entered from an outside of second light guide 30B, and causes the image light deflected to propagate through second light guide 30B; and second folding hologram element 42B that further deflects, by diffraction, the image light diffracted by second input hologram element 41B, and causes the image light further deflected to propagate through second light guide 30B. Moreover, third light guide 30C further includes: third input hologram element 41C that deflects, by diffraction, the image light that has entered from an outside of third light guide 30C, and causes the image light deflected to propagate through third light guide 30C; and third folding hologram element 42C that further deflects, by diffraction, the image light diffracted by third input hologram element 41C, and causes the image light further deflected to propagate through third light guide 30C. First output hologram element 43A further deflects, by diffraction, the image light deflected by the diffraction by first folding hologram element 42A, and causes the image light further deflected to exit first light guide 30A. Second output hologram element 43B further deflects, by diffraction, the image light deflected by the diffraction by second folding hologram element 42B, and causes the image light further deflected to exit second light guide 30B. Third output hologram element 43C further deflects, by diffraction, the image light deflected by the diffraction by third folding hologram element 42C, and causes the image light further deflected to exit third light guide 30C.

With this, it is possible to realize display device 1 that is capable of further reducing a decrease in the quality of the image displayed on the display medium.

Moreover, in display device 1 according to the present embodiment, first input hologram element 41A deflects, by diffraction, light of a first wavelength component included in the image light that has entered first input hologram element 41A, and causes the light deflected to propagate through first light guide 30A. Second input hologram element 41B deflects, by diffraction, light of a second wavelength component included in the image light that has entered second input hologram element 41B, and causes the light deflected to propagate through second light guide 30B. third input hologram element 41C deflects, by diffraction, light of a third wavelength component included in the image light that has entered third input hologram element 41C, and causes the light deflected to propagate through third light guide 30C.

With this, it is possible to cause the three wavelength components included in the image light to enter the three light guides that are first light guide 30A, second light guide 30B, and third light guide 30C in one-to-one correspondence, thereby reducing a decrease in intensity of the image light. As a result, it is possible to further reduce a decrease in the quality of the image displayed on the display medium.

In display device 1 according to the present embodiment, the first wavelength component is a wavelength component that corresponds to blue. The second wavelength component is a wavelength component that corresponds to green. The third wavelength component is a wavelength component that corresponds to red.

With this, it is possible to divide the image light into three wavelength components that can represent images clearly, to cause the three divided wavelength components to enter the three light guides that are first light guide 30A, second light guide 30B, and third light guide 30C in one-to-one correspondence. As a result, it is possible to further reduce a decrease in the quality of the image displayed on the display medium.

In display device 1 according to the present embodiment, the light quantity distribution of the image light exiting first output hologram element 43A depends on a diffraction efficiency that indicates a rate of an intensity of the image light diffracted by first output hologram element 43A relative to an intensity of the image light entering first output hologram element 43A. The light quantity distribution of the image light exiting second output hologram element 43B depends on a diffraction efficiency that indicates a rate of an intensity of the image light diffracted by second output hologram element 43B relative to an intensity of the image light entering second output hologram element 43B.

With this, by adjusting the diffraction efficiency, the light quantity distribution of the image light exiting first output hologram element 43A and second output hologram element 43B can be adjusted. As a result, it is possible to further reduce a decrease in the quality of the image displayed on the display medium.

### (Variation of Embodiment)

The present variation differs from the display device according to the embodiment in that display device 1a further includes phase retarder 30D. Unless otherwise specified, the other structural elements in the present variation are similar to those of the display device according to the embodiment. The similar structural elements are marked with the same reference numerals, and will not be described in detail.

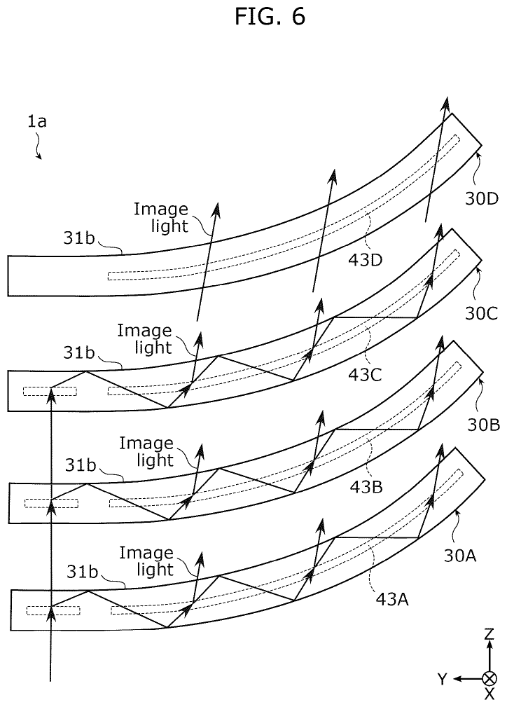

A configuration of display device 1a will be described with reference to FIG. 6. FIG. 6 is a schematic diagram of display device 1a according to the variation of the embodiment, viewed along the right direction.

In the present variation, display device 1a includes phase retarder 30D in addition to image generating device 20, first light guide 30A, second light guide 30B, and third light guide 30C.

Phase retarder 30D is positioned away from third light guide 30C by a predetermined distance, and is positioned further on the positive Z-axis side relative to third light guide 30C.

Phase retarder 30D is in a curved shape in the same manner as first light guide 30A, second light guide 30B, and third light guide 30C. Specifically, phase retarder 30D is generally rectangular in shape when viewed along the Z-axis direction, and is in a shape of a curved plate that is bent upward on the negative Y-axis side relative to the Y-axis direction.

The image light that has exited third light guide 30C enters phase retarder 30D. Phase retarder 30D applies a phase shift to the polarization component of the image light before the image light exits phase retarder 30D. In other words, phase retarder 30D applies a phase shift to the third deflected light that is the light of the third wavelength component (image light) that has exited third light guide 30C, the third deflected light that is the light of the second wavelength component light (image light) that has passed through and exited third light guide 30C, the third deflected light that is the light of the first wavelength component (image light) that has passed through and exited third light guide 30C and second light guide 30B, before each third deflected light exits phase retarder 30D.

Image generating device 20 emits image light that includes p-polarized light to first light guide 30A and the like, so that the image light that has passed through third light guide 30C is p-polarized light. Phase retarder 30D applies a phase shift to the polarization component of the p-polarized image light, so that the image light that includes s-polarized light exits phase retarder 30D. In other words, phase retarder 30D converts a portion of the p-polarized image light into s-polarized image light, so that image light that includes both p-polarized light and s-polarized light exits phase retarder 30D. In the image light according to the present embodiment, the quantity of p-polarized light is larger than the quantity of s-polarized light. Head-up displays according to a conventional technique may use s-polarized light for actively causing reflection on the windshield. However, because an air layer is provided between two adjacent light guides according to the present variation, image light may be reflected by the back surfaces of these light guides when the image light enters the respective light guides. Therefore, p-polarized light may be used to prevent reflection by the light guides.

In view of the above, when only p-polarized light exits the first light guide, it is possible to reduce an increase in Fresnel reflection of the image light on the second light guide and the third light guide. However, since the transmittance of p-polarized light tends to be higher than the transmittance of s-polarized light in the range of a predetermined entrance angle, p-polarized light easily passes through the windshield and is not easily reflected by the entrance surface of the windshield. This makes it difficult for the user to recognize the image, and may degrade the quality of the image displayed on windshield 3.

Therefore, it is necessary to the image light to be reflected by the windshield while reducing reflection of the image light by the back surfaces of the second light guide, the third light guide, and the like.

Display device 1a according to the present variation further incudes third light guide 30C that is in a curved shape and includes third output hologram element 43C; and phase retarder 30D from which the image light that has exited third light guide 30C enters, the phase retarder applying a phase shift to a deflection component of the image light that has entered phase retarder 30D before the image light exits phase retarder 30D.

With this, the image light that has exited third light guide 30C enters phase retarder 30D. Therefore, it is possible that p-polarized light enters phase retarder 30D, and the image light that includes p-polarized light and s-polarized light exits phase retarder 30D. This allows a portion of the light in the image light to be reflected by windshield 3, so that the user is able to recognize the image reliably.

In display device 1a according to the present variation, image generating device 20 emits the image light that includes p-polarized light to first light guide 30A. Phase retarder 30D applies a phase shift to a polarization component of the image light that has entered phase retarder 30D, and causes the image light that includes s-polarized light to exit phase retarder 30D.

This allows the image light before entering phase retarder 30D to be p-polarized light. As a result, it is possible to reduce an increase in stray light by reducing generation of light reflected by the light guides other than first light guide 30A.

Phase retarder 30D applies a phase difference to the image light, so that the image light including s-polarized light exits phase retarder 30D. This allows the image light to be reflected by windshield 3. As a result, it is possible to reduce a decrease in the quality of the image displayed on the display medium.

In other words, in the present embodiment, both the reflection of image light by the light guides and the reflection of the image light by windshield 3 can be reduced.

### (Other Variations)

Although the display device according to the present disclosure has been described based on the above embodiment, the present disclosure is not limited to the embodiment. A form obtained by making various modifications conceivable by those skilled in the art to the embodiment without departing from the gist of the present disclosure are also included in the scope of the present disclosure.

A form obtained by making various modifications conceivable by those skilled in the art to the embodiment, and a form realized by arbitrarily combining the structural elements and functions in the embodiment without departing from the spirit of the present disclosure are also included in the present disclosure.

While various embodiments have been described herein above, it is to be appreciated that various changes in form and detail may be made without departing from the spirit and scope of the present disclosure as presently or hereafter claimed.

Further Information About Technical Background to this Application

The disclosures of the following patent applications including specification, drawings, and claims are incorporated herein by reference in their entirety: Japanese Patent Application No. 2022-059644 filed on Mar. 31, 2022, and PCT International Application No. PCT/JP2023/005245 filed on Feb. 15, 2023.

### INDUSTRIAL APPLICABILITY

The present disclosure is usable for, for example, head-up display devices in vehicles.

1. A display device comprising:
an image generating device that generates image light that indicates an image;
a first light guide that includes a first output hologram element from which the image light exits; and
a second light guide that includes a second output hologram element from which the image light exits,
wherein each of the first light guide and the second light guide is in a curved shape,
the image light emitted from the image generating device enters the first light guide,
a portion of the image light that has entered the first light guide enters the second light guide, and
a light quantity distribution of the image light exiting the first output hologram element is different from a light quantity distribution of the image light exiting the second output hologram element.

2. The display device according to claim 1,
wherein the first light guide is curved to be bent upward relative to a horizontal direction, and
the light quantity distribution of the image light exiting the first output hologram element differs depending on a horizontal position on the first output hologram element.

3. The display device according to claim 1,
wherein an angle of the image light exiting the first light guide relative to a surface of the first light guide differs depending on an exit position of the image light on the surface of the first light guide.

4. The display device according to claim 3,
wherein the light quantity distribution of the image light exiting the first output hologram element increases with a decrease in the angle of the image light exiting the first light guide.

5. The display device according to claim 3,
wherein the first output hologram element includes a first region and a second region that is different from the first region,
an average value of angles of the image light exiting a region of the first light guide corresponding to the first region is greater than an average value of angles of the image light exiting a region of the first light guide corresponding to the second region, and
the light quantity distribution in the first region of the first output hologram element is smaller than the light quantity distribution in the second region of the first output hologram element.

6. The display device according to claim 1, further comprising:
a third light guide that is in a curved shape and includes a third output hologram element,
wherein a portion of the image light that has entered the first light guide enters the second light guide,
a portion of the image light that has entered the second light guide enters the third light guide, and
the light quantity distribution of the image light exiting the second output hologram element differs depending on a horizontal position on the second output hologram element.

7. The display device according to claim 6,
wherein an angle of the image light exiting the second light guide relative to a surface of the second light guide differs depending on an exit position of the image light on the surface of the second light guide,
the light quantity distribution of the image light exiting the second output hologram element increases with a decrease in the angle of the image light exiting the second light guide, and
the light quantity distribution at a predetermined position on the second output hologram element is smaller than the light quantity distribution at a position on the first output hologram element corresponding to the predetermined position.

8. The display device according to claim 6,
wherein the first output hologram element includes a first region and a second region that is different from the first region,
an angle of the image light exiting the second light guide differs depending on an exit position of the image light on a surface of the second light guide,
an average value of angles of the image light exiting a region of the second light guide corresponding to the first region is greater than an average value of angles of the image light exiting a region of the second light guide corresponding to the second region,
the light quantity distribution in a region of the second output hologram element corresponding to the first region is smaller than the light quantity distribution in a region of the second output hologram element corresponding to the second region, and
the light quantity distribution in a predetermined region of the second output hologram element is smaller than the light quantity distribution in a region of the first output hologram element corresponding to the predetermined region.

9. The display device according to claim 6,
wherein the first light guide further includes:
a first input hologram element that deflects, by diffraction, the image light that has entered from an outside of the first light guide and causes the image light deflected to propagate through the first light guide; and
a first folding hologram element that further deflects, by diffraction, the image light diffracted by the first input hologram element and causes the image light further deflected to propagate through the first light guide,
the second light guide further includes:
a second input hologram element that deflects, by diffraction, the image light that has entered from an outside of the second light guide, and causes the image light deflected to propagate through the second light guide; and
a second folding hologram element that further deflects, by diffraction, the image light diffracted by the second input hologram element, and causes the image light further deflected to propagate through the second light guide,
the third light guide further includes:
a third input hologram element that deflects, by diffraction, the image light that has entered from an outside of the third light guide, and causes the image light deflected to propagate through the third light guide; and
a third folding hologram element that further deflects, by diffraction, the image light diffracted by the third input hologram element, and causes the image light further deflected to propagate through the third light guide,
the first output hologram element further deflects, by diffraction, the image light deflected by the diffraction by the first folding hologram element, and causes the image light further deflected to exit the first light guide,
the second output hologram element further deflects, by diffraction, the image light deflected by the diffraction by the second folding hologram element, and causes the image light further deflected to exit the second light guide, and
the third output hologram element further deflects, by diffraction, the image light deflected by the diffraction by the third folding hologram element, and causes the image light further deflected to exit the third light guide.

10. The display device according to claim 9,
wherein the first input hologram element deflects, by diffraction, light of a first wavelength component included in the image light that has entered the first input hologram element, and causes the light deflected to propagate through the first light guide,
the second input hologram element deflects, by diffraction, light of a second wavelength component included in the image light that has entered the second input hologram element, and causes the light deflected to propagate through the second light guide, and
the third input hologram element deflects, by diffraction, light of a third wavelength component included in the image light that has entered the third input hologram element, and causes the light deflected to propagate through the third light guide.

11. The display device according to claim 10,
wherein the first wavelength component is a wavelength component that corresponds to blue,
the second wavelength component is a wavelength component that corresponds to green, and
the third wavelength component is a wavelength component that corresponds to red.

12. The display device according to claim 1, further comprising:
a third light guide that is in a curved shape and includes a third output hologram element; and
a phase retarder from which the image light that has exited the third light guide enters, the phase retarder applying a phase shift to a deflection component of the image light that has entered the phase retarder before the image light exits the phase retarder.

13. The display device according to claim 12,
wherein the image generating device emits the image light that includes p-polarized light to the first light guide, and
the phase retarder applies a phase shift to a polarization component of the image light that has entered the phase retarder, and causes the image light that includes s-polarized light to exit the phase retarder.

14. The display device according to claim 1,
wherein the light quantity distribution of the image light exiting the first output hologram element depends on a diffraction efficiency that indicates a rate of an intensity of the image light diffracted by the first output hologram element relative to an intensity of the image light entering the first output hologram element, and
the light quantity distribution of the image light exiting the second output hologram element depends on a diffraction efficiency that indicates a rate of an intensity of the image light diffracted by the second output hologram element relative to an intensity of the image light entering the second output hologram element.
